(19) United States
(12) Patent Application Publication
(10) Pub. No.: US 2010/0094244 A1
(43) Pub. Date: Apr. 15, 2010

(54) PIERCEABLE CLOSURE FOR MEDICINE CONTAINERS

(75) Inventor: Bernhard Pech, Niedernhausen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: West Pharmaceutical Services Deutschland GmbH & Co, Eschweiler (DE)

(21) Appl. No.: 12/520,404

(22) PCT Filed: Dec. 10, 2007
(86) PCT No.: PCT/EP07/10760

§ 371 Date: Jun. 19, 2009

(30) Foreign Application Priority Data
Dec. 20, 2006 (DE) 10 2006 061 000.8

(51) Int. Cl. A61J 1/14

(52) U.S. Cl. 604/415

(57) ABSTRACT

A pierceable closure, such as a cap for a bottle for infusion solutions, has a peelable and sealable foil as a sterile cover of the pierceable location, which is configured as a metal or aluminum foil and which is connected or sealed to the closure in a peelable at a distance around the pierceable location. The cover has at least one aperture or one opening with the fastening region to which the same is applied, wherein the aperture or opening is closed in a sterile manner by means of a foil or membrane that is permeable to water vapor such that the closure can be sterilized by means of autoclaving even beneath the cover.

### CROSS-REFERENCE TO RELATED APPLICATIONS

This application is a Section 371 of International Application No. PCT/EP2007/010760, filed Dec. 10, 2007, which was published in the German language on Jul. 3, 2008, under International Publication No. WO 2008/077475 A1, and the disclosure of which is incorporated herein by reference.

### BACKGROUND OF THE INVENTION

The invention relates to a pierceable closure for medicine containers. The closure includes a detachable, sterile cover for the pierceable position of the closure. The cover is preferably made of a metal or aluminum foil, which is connected or sealed to the closure with a spacing around the pierceable position, so that it can be ripped or peeled off, wherein the connection region of the foil is formed so that it completely surrounds the pierceable position.

Such closures for medicine containers with a cover for the pierceable position made of aluminum or an aluminum-plastic laminate are known and serve for indicating evidence of tampering and also for sterile covering the puncturable or pierceable position of corresponding closures or caps, for example, for bottles holding infusion solutions. For use, the usually sealed cover foil can be pulled off. Because this foil, which is made of aluminum or metal, is impermeable to water vapor, up until now a clean-room production was required in order to guarantee sufficient sterility under the foil.

If one were to use instead a foil without an aluminum or metal component, only a low sealing temperature and low mechanical stability, and also a low cold deformability would be possible. In addition, such a cover foil could be deformed undesirably, for example crumpled or warped, due to temperature effects during the autoclaving.

### BRIEF SUMMARY OF THE INVENTION

Therefore, the object arises of creating a closure of the type named above, in which the advantages of a metal or aluminum foil, in particular, the good stability against undesired deformations due to temperature effects during the autoclaving, as well as the possibility of using high sealing temperatures, is maintained, but nevertheless the environment necessary for adequate sterilization can be generated, even under this cover, through autoclaving or steam autoclaving.

For solving these apparently contradictory objects, the pierceable closure defined above and its cover or cover foil are characterized in that this cover has, within the attachment region, at least one break-out or an opening, which is closed in a sterile way with a water vapor-permeable foil or membrane.

In this way, the advantages of metal or aluminum foils and those of water vapor-permeable foils are combined. During the autoclaving procedure, the moisture can pass through the break-out of the aluminum foil and the water vapor-permeable membrane arranged there and thereby guarantee the environment necessary for this sterilization process. Then, this moisture can escape again through the water vapor-permeable foil or membrane. At the same time, good plastic cold deformation of the cover can still be maintained, that is, for example, holding tabs for peeling off the foil can undergo the desired permanent deformation after the displacement. Furthermore, the favorable high sealing temperature for aluminum foils can be used, which produces fast softening of the sealing partners. Consequently, clearly impressed sealing seams can be generated that compensate for possibly existing unevenness, which could otherwise lead to unsealed portions of the sealing seam, and which also allow the desired quality of the sealing seam to be inspected visually in a non-destructive way.

After attachment to the container, the closures are often sterilized by autoclaving together with the container. The arrangement according to the invention makes it possible that the region underneath the foil is also sterilized by this final sterilization, that is, the autoclaving procedure possible by the invention can be performed by this final sterilization, so that no additional processing steps are required.

In addition, there is good stability against deformation, such as, creasing or warping, due to temperature effects during the autoclaving. Because the connection between the cover foil made of metal or aluminum and the water vapor-permeable foil or membrane does not have to be detachable or peelable, there is a large selection of possible connection media for connecting the cover foil to the water vapor-permeable foil or membrane according to the invention. For example, hot adhesives could be used for this purpose.

It is preferred when the water vapor-permeable foil is made of plastic, paper, non-woven fabric, and/or woven fabric. These are proven materials for a cover that is sterile and nevertheless permeable to water vapor. The membrane according to the invention can grip over the edge of the opening of the foil on the side facing towards and/or away from the closure. If it is provided on the side facing the closure, it is also gripped by the foil and held in the closed position. In contrast, if it is attached on the side facing away from the closure, it is better guaranteed that it is taken along when the cover foil is peeled away, because it is also lifted every time the film is lifted.

It is further possible that the closure has at least two pierceable positions and a foil cover that covers all of the pierceable positions and that is connected to the closure by being sealed between these pierceable positions. In addition, the cover can have an opening closed with a water vapor-permeable foil in all of the areas of the pierceable positions. Thus, the user can first expose a pierceable position, but also has the ability, if necessary, to puncture the cover a second time at the second position that is initially closed in a sterile way. Simultaneously, both regions are sterilized during the autoclaving due to the vapor-permeable foil or membrane.

The opening closed by a water vapor-permeable foil piece or such a membrane could have a size of approximately two square millimeters or more, for example, of approximately three, four, or five square millimeters or appropriate intermediate values. This produces a sufficiently large surface area, in order to allow the vapor to also reach under the cover foil during the autoclaving and to allow the sterilizing effect to be used, wherein, however, the advantageous cover foil made of metal or aluminum can simultaneously satisfy its closing function to a good degree.

The water vapor-permeable foil or membrane can be connected rigidly and not detachably to the cover, for example, by means of hot adhesive.

Primarily for the combination of individual or several of the previously described features and measures, a pierceable closure is produced for medicine containers in which, through the combination of a metal or aluminum foil with a water vapor-permeable foil or membrane, the pierceable position can be covered in a sterile way and nevertheless can still be autoclaved.

Below, an embodiment of the invention is described in more detail with reference to the drawing.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a perspective view of a pierceable closure for medicine containers in accordance with a preferred embodiment of the present invention.

### DETAILED DESCRIPTION OF THE INVENTION

Here, the sole FIGURE shows, in a perspective diagram, a cap-like, pierceable closure with a cover for the pierceable position, with this cover being able to be detached through peeling, wherein two pierceable positions are provided and the peelable cover reaching across both positions is to be seen in the position of use at one pierceable position and in an exploded-view representation at the other pierceable position.

A pierceable closure designated as a whole with 1 for medicine containers has approximately the shape of a cap and has two pierceable positions 2 on the top side facing away from the medicine container in the position of use. In the original position, these pierceable positions are covered by a detachable, sterile cover 3 that is formed as a metal or aluminum foil and that is connected, preferably sealed with the closure 1 around the pierceable positions 2 so that it can be ripped or peeled off. Here, this cover 3 covers both pierceable positions 2 and is shown detached on one half in the sole figure for the sake of a better overall view or separated from the other half still located in the position of use.

Here, the connection region 4 or attachment region, also called “attachment region 4” below, is formed completely surrounding the pierceable position 2, that is, in the embodiment, this attachment position 4 also runs between the two pierceable positions 2, so that each pierceable position 2 can be made accessible by lifting and pulling off the cover 3, without the other pierceable position 2 already being exposed.

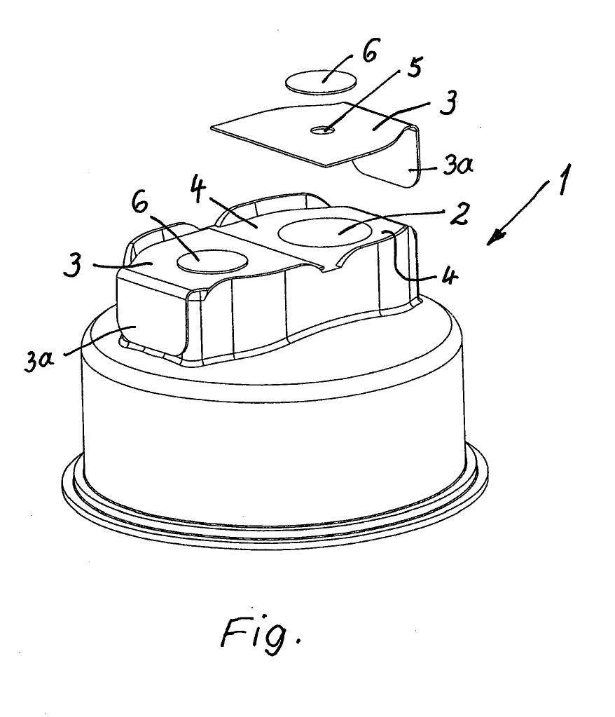

In FIG. 1, one clearly sees that the cover 3 has, within the attachment region 4, a break-out or an opening 5 that is closed in a sterile way with a water vapor-permeable foil or membrane 6. This water vapor-permeable foil 6 can be made of plastic, paper, non-woven fabric, and/or woven fabric and also allows the sterilization of the pierceable region underneath the cover 3, in which, during the autoclaving, hot steam can pass through this membrane 6 and sterilize and then also escape again, so that the advantages of a metal or aluminum foil are combined with a water vapor-permeable foil.

In the embodiment, the membrane 6 grips over the edge of the opening 5 of the foil 3 on the side facing away from the closure 1, so that the membrane 6 is reliably lifted every time the film 3 is pulled off when its tab 3a is gripped.

As already mentioned, in the embodiment, the closure 1 has two pierceable positions 2 and a foil cover 3 that covers the two pierceable positions 2, wherein, for each pierceable position 2, a separate foil cover 3 with an opening 5 and membrane 6 or a continuous cover 3 with two openings 5 and two membranes 6 could be provided. The membrane 6 is preferably connected to the cover 3 made of metal, for example, by a hot adhesive. The opening 5 can have a size of at least approximately two square millimeters or also more, for example, of approximately three, four, or five square millimeters or an intermediate value. This size could be selected according to the total size of the cover 3 and the requirement to be able to let the vapor, during the autoclaving, to penetrate as quickly as possible into and under the attached cover 3.

The pierceable closure 1, for example, a cap for a bottle for infusion solutions, has a peelable, sealable foil as a sterile cover 3 of the pierceable position 2 that is formed as a metal or aluminum foil and is connected or sealed detachably to the closure 1 at a distance around the pierceable position 2. Within the attachment region 4 loaded by the cover, this cover 3 has at least one break-out or opening 5 that is closed in a sterile way with a water vapor-permeable foil or membrane 6, so that the closure 1 can also be sterilized by autoclaving underneath this cover 3.

Through this arrangement, later contamination of the pierceable position or positions 2 is prevented and a tamper-evident closure is simultaneously formed.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1-6. (canceled)

7. A pierceable closure for medicine containers, the closure comprising a detachable, sterile cover of a pierceable position of the closure, the cover made of a metal or aluminum foil that is connected or sealed to the closure with a spacing around the pierceable position, so that it can be ripped or peeled off, wherein a connection region or attachment region of the cover is formed completely surrounding the pierceable position, and wherein the cover has, within the attachment region, at least one break-out or opening that is closed in a sterile way with a water vapor-permeable foil or membrane.

8. The pierceable closure according to claim 7, wherein the water vapor-permeable foil is made of plastic, paper, non-woven fabric, and/or woven fabric.

9. The pierceable closure according to claim 7, wherein the membrane grips over an edge of the opening of the foil on a side facing towards and/or away from the closure.

10. The pierceable closure according to claim 7, wherein the closure has at least two pierceable positions and a foil cover that covers all of the pierceable positions and that is connected to the closure by sealing between these pierceable positions, and wherein the cover has an opening closed with the water vapor-permeable foil or membrane in all of the regions belonging to the pierceable positions.

11. The pierceable closure according to claim 7, wherein the opening closed by the water vapor-permeable foil or membrane has a size of at least approximately two square millimeters or more.

12. The pierceable closure according to claim 7, wherein the water vapor-permeable foil or membrane is connected rigidly and not detachably to the cover.
